(19) United States
(12) Patent Application Publication
(10) Pub. No.: US 2025/0238173 A1
(43) Pub. Date: Jul. 24, 2025

(54) NON-TRANSITORY COMPUTER-READABLE STORAGE MEDIUM STORING VIRTUAL PRINTER PROGRAM, PRINTING CONTROL DEVICE, AND PRINTING METHOD

(71) Applicant: SEIKO EPSON CORPORATION, Tokyo (JP)

(72) Inventor: Tomoki MATSUZAWA, Shiojiri (JP)

(21) Appl. No.: 19/032,485

(22) Filed: Jan. 21, 2025

(30) Foreign Application Priority Data
Jan. 23, 2024 (JP) 2024-007951

(51) Int. Cl. G06F 3/12

(52) U.S. Cl. CPC G06F 3/1228; G06F 3/1203; G06F 3/1288

(57) ABSTRACT

According to an aspect of the present disclosure, there is provided a non-transitory computer-readable storage medium storing a virtual printer program, the virtual printer program causing a computer to execute first communication processing, second communication processing, and printing processing. The first communication processing is processing of pretending a printer for a general-purpose printer driver and communicating with the general-purpose printer driver. In the second communication processing, communication is performed with a print server. In the printing processing, a print job acquired from the general-purpose printer driver in the first communication processing is transmitted to the print server: in the second communication processing to cause a printer connected to the print server via a network to perform printing.

The present application is based on, and claims priority from JP Application Serial Number 2024-007951, filed Jan. 23, 2024, the disclosure of which is hereby incorporated by reference herein in its entirety.

### BACKGROUND

### 1. Technical Field

The present disclosure relates to a non-transitory computer-readable storage medium storing a virtual printer program, a printing control device, and a printing method.

### 2. Related Art

JP-A-2021-43547 discloses a technique for reducing the time and effort of a user required for downloading and installing a driver specific to a printer vendor even in an environment in which an OS (Operating System) standard printer driver is installed. A general-purpose printer driver such as an OS-standard printer driver does not support printing via a print server, that is, cloud printing or on-premises printing.

JP-A-2021-43547 is an example of the related art.

There is a desire to enable printing via a print server, i.e., cloud printing or on-premises printing, using a general-purpose printer driver such as an OS standard printer driver without using a driver specific to a printer vendor.

### SUMMARY

According to an aspect of the present disclosure, there is provided a non-transitory computer-readable storage medium storing a virtual printer program, the virtual printer program causing a computer to execute: first communication processing of pretending a printer for a general-purpose printer driver and communicating with the general-purpose printer driver; second communication processing of communicating with a print server; and printing processing of transmitting a print job acquired from the general-purpose printer driver in the first communication processing to the print server in the second communication processing and causing a printer connected to the print server via a network to perform printing.

According to an aspect of the present disclosure, there is provided a printing control device including: a general-purpose printer driver; a first communication processing unit configured to pretend a printer for a general-purpose printer driver and communicate with the general-purpose printer driver; a second communication processing unit configured to perform communication with a print server; and a printing processing unit configured to transmit a print job acquired from the general-purpose printer driver by the first communication processing unit to the print server with the second communication processing unit and cause a printer connected to the print server via a network to perform printing.

According to an aspect of the present disclosure, there is provided, there is provided a printing method including printing processing of: transmitting, to a print server, a print job acquired from a general-purpose printer driver by pretending a printer for the general-purpose printer driver and communicating with the general-purpose printer driver; and causing a printer connected to the print server via a network to perform printing based on the print job.

### BRIEF DESCRIPTION OF THE DRAWINGS

FIG. 1 is a block diagram illustrating a configuration example of a print system according to an embodiment.

FIG. 2 is a sequence diagram illustrating an example of printer queue registration processing in the print system illustrated in FIG. 1.

FIG. 3 is a diagram illustrating an example of a user interface image displayed in the registration processing illustrated in FIG. 2.

FIG. 4 is a diagram illustrating an example of a user interface image displayed when cloud setting is selected in the user interface image illustrated in FIG. 3.

FIG. 5 is a diagram illustrating an example of a setting file generated in the registration processing illustrated in FIG. 2.

FIG. 6 is a sequence diagram illustrating a first example of printing processing executed by the print system illustrated in FIG. 1.

FIG. 7 is a block diagram illustrating a detailed example of a part of the print system illustrated in FIG. 1 and illustrating a configuration example of the print system that executes the printing processing illustrated in FIG. 6.

FIG. 8 is a sequence diagram illustrating a second example of the printing processing executed by the print system illustrated in FIG. 1.

FIG. 9 is a block diagram illustrating a detailed example of a part of the print system illustrated in FIG. 1 and illustrating a configuration example of the print system that executes the printing processing illustrated in FIG. 8.

FIG. 10 is a sequence diagram illustrating printing processing executed by a print system according to a reference example.

FIG. 11 is a block diagram illustrating details of a part of the print system according to the reference example and illustrating a configuration of the print system that executes the printing processing illustrated in FIG. 10.

FIG. 12 is a diagram illustrating an example of a hardware configuration of a device.

### DESCRIPTION OF EMBODIMENTS

An embodiment of the present disclosure is explained below with reference to the drawings. Figures are merely exemplification for explaining the embodiment of the present disclosure. Not all of elements explained in the embodiment of the present disclosure are essential elements of the present disclosure.

### Embodiment

### Configuration of a System

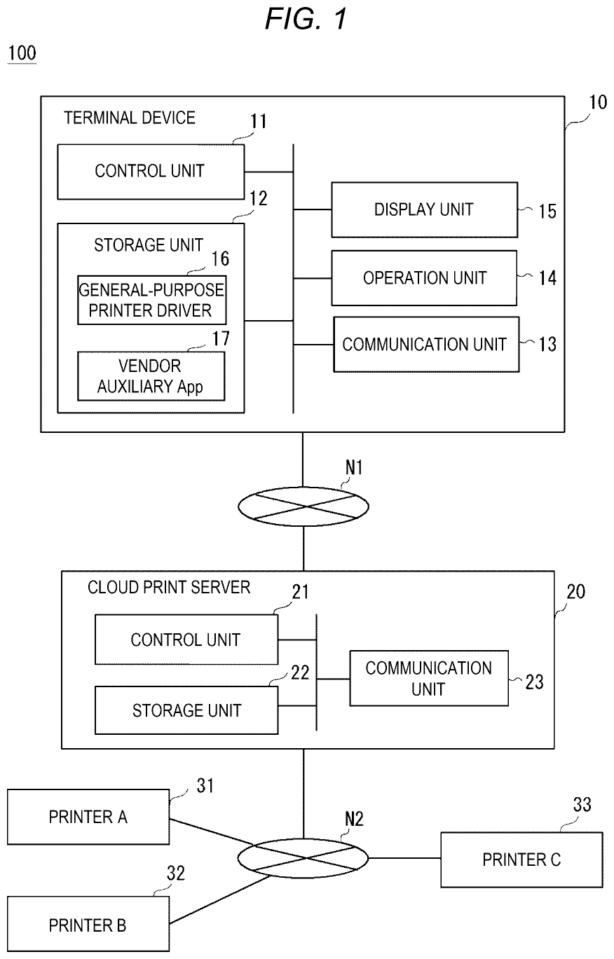

An exemplary configuration of a print system according to the present embodiment is explained with reference to FIG. 1. FIG. 1 is a block diagram illustrating the configuration example of the print system according to the embodiment.

As illustrated in FIG. 1, a print system 100 according to the present embodiment can include a terminal device 10, a cloud print server 20, a printer A(31), a printer B(32), and a printer C(33).

In the following explanation, the print system 100 illustrated in FIG. 1 is explained as an example of the print system according to the embodiment. However, any plurality of components in the print system 100 such as portions configured by the terminal device 10 and the cloud print server 20 can also be referred to as print system. In this specification, a cloud print server indicates a cloud print server computer or a cloud print server device.

The terminal device 10 is an information processing device including a communication function such as a personal computer (PC), a smartphone, or a tablet terminal and can be used by a user who desires printing. The terminal device 10 is connected to the cloud print server 20 via a network N1 for, for example, processing of transmitting a print request. Since the terminal device 10 controls printing, the terminal device 10 can be referred to as printing control device. Since the terminal device 10 functions as a client of the cloud print server 20, the terminal device 10 can also be referred to as client, client computer, or the like. Although not illustrated, the print system 100 can include a plurality of terminal devices 10.

The cloud print server 20 is a server for providing a print service on the cloud. The cloud print server 20 can be constructed as a device that enables a print request and print data to be transmitted using a URI (Uniform Resource Identifier). The cloud print server 20 is connected to a printer A(31), a printer B(32), and a printer C(33) via a network N2 for, for example, processing of transmitting a print request. The cloud print server 20 can also transmit print requests and print data to the printer A(31), the printer B(32), and the printer C(33) via a VPN (Virtual Private Network). Naturally, the cloud print server 20 can also be constructed as a cloud print system in which functions necessary for providing cloud printing are distributed to a plurality of servers.

All of the printer A(31), the printer B(32), and the printer C(33) are example of a printer and, when receiving print data, can print the print data on a medium. For convenience, the print system 100 is explained on the premise that three printers are provided in the print system 100 as explained above. However, at least one printer only has to be provided in the print system 100. The printers only have to be devices having a communication function and a print function but may be a multifunction peripheral having other functions such as a scanner function, a copy function, and a facsimile transmission function. The printers can also be referred to as printing apparatus or image forming apparatus. Printing schemes in the printers do not matter. Various printing schemes such as an inkjet printing scheme and a laser printing scheme can be applied.

The print system 100 performs printing from a selected printer among the printer A(31), the printer B(32), and the printer C(33) via the cloud print server 20 according to user operation from the terminal device 10. In the following explanation, configuration examples of the terminal device 10 and the cloud print server 20 are explained in detail. Note that explanation of a configuration example of the printers is omitted.

### 1. Configuration of the Terminal Device 10

As illustrated in FIG. 1, the terminal device 10 can include a control unit 11, a storage unit 12, a communication unit 13, an operation unit 14, and a display unit 15.

The control unit 11 controls the entire terminal device 10. The control unit 11 can include, for example, an arithmetic processing device, a working memory, and a storage device that stores a control program, parameters, and the like. The arithmetic processing device can be a central processing unit (CPU), a graphics processing unit (GPU), or the like. The control unit 11 can also be implemented as a system on a chip (SoC). As it is seen from the examples explained above, the control unit 11 can be configured to store the control program in an executable state. However, the control unit 11 can also be configured to store a part of the control program as a circuit configuration like a field programable gate array (FPGA) or can be configured as a dedicated circuit.

The control program can include a program for the arithmetic processing device to execute processing relating to printing in cooperation with the storage unit 12, the communication unit 13, the operation unit 14, and the display unit 15. The control program can include an OS. Since the OS is an OS equipped in the terminal device 10, the OS is an OS of a type corresponding to a model and the like of the terminal device 10. The control program can include a Web browser in the OS or outside the OS. In the following explanation, an example in which at least a part of the control program is stored in the storage unit 12 provided separately from the control unit 11 is explained. However, the storage unit 12 may be a part of a storage device in the control unit 11. That is, the storage unit 12 can be grasped as a part of the control unit 11.

The storage unit 12 is, for example, a storage device by a hard disk drive, a solid state drive, or another memory. The storage unit 12 stores, as part of the control program, a general-purpose printer driver 16 and a vendor auxiliary Application program 17 explained below in a state executable from the control unit 11. In the following explanation, the vendor auxiliary Application program is abbreviated as vendor auxiliary App. The storage unit 12 can store various data such as a file to be printed.

The communication unit 13 is a part that conforms to a predetermined communication standard such as various mobile communication standards and Wi-Fi (registered trademark; the same applies below) standard and communicates with an external device such as the cloud print server 20 by radio or wire via the network N1. The communication unit 13 can be configured by one or a plurality of communication interfaces capable of performing such communication.

The operation unit 14 is a part that receives operation by a user of the terminal device 10 and can be referred to as operation reception unit as well. The operation unit 14 can be implemented, for example, by any one or a plurality of physical buttons, a touch panel mounted on the display unit 15, a pointing device, a keyboard, and the like. In a configuration in which the operation unit 14 includes the touch panel, the operation unit 14 including the display unit 15 and the touch panel can be referred to as operation panel of the terminal device 10.

The display unit 15 is a part for displaying a user interface (UI) image for operating the terminal device 10 and is configured by a display device such as a liquid crystal display or an organic electroluminescence display. The display unit 15 can also include a display and a drive circuit for driving the display.

The general-purpose printer driver 16 is explained. The general-purpose printer driver 16 is an OS standard printer driver included in the OS included in the control program or attached to the OS. The general-purpose printer driver 16 can be, for various types of printers, a program capable of controlling the printers to execute printing. The general-purpose printer driver 16 can be referred to as OS general-purpose printing program or general-purpose printing program as well.

The general-purpose printer driver 16 is a driver that uses a general-purpose protocol for a search for a printer and for printing. The general-purpose printer driver 16 uses, for example, mDNS/DNS-SD for the search for a printer and uses IPP for the printing in the printer. Here, DNS is an abbreviation of Domain Name System. mDNS is an abbreviation of multicast DNS. DNS-SD is an abbreviation of DNS Service Discovery. IPP is an abbreviation of Internet Print Protocol.

As it is seen from this example, the general-purpose printer driver 16 can be, for example, an IPP Class driver. IPP is an example of a standard protocol for controlling the management and printing of printers. The IPP acquires and controls printer information according to HTTP (Hyper Text Transfer Protocol) POST requests and responses. In the IPP, it is possible to perform printer setting and printer state acquisition. Here, secure communication can be performed by using HTTPS (HTTP Secure) instead of the HTTP.

The vendor auxiliary App 17 is explained. The vendor auxiliary App 17 is an application program that assists the general-purpose printer driver 16 and is used to extend the functions of the general-purpose printer driver 16. Therefore, the general-purpose printer driver 16 can include functions of starting the vendor auxiliary App 17 and transmitting a print job to the vendor auxiliary App 17.

The vendor auxiliary App 17 can be a program for assisting the general-purpose printer driver 16 and causing a computer to execute print control suitable for the performance of a target printer, that is, print control for supporting a unique function of the printer. Here, the computer indicates the terminal device 10 or the control unit 11. When acquiring a print job from the general-purpose printer driver 16, the vendor auxiliary App 17 can convert the print job such that printing using a unique function for a designated printer can be executed by the printer.

The vendor auxiliary App 17 is an application program provided by, for example, a vendor of a printer. The vendor auxiliary App 17 can be provided to the user of the terminal device 10 by being disclosed in, for example, an application store of an OS provider. Alternatively, the vendor auxiliary App 17 can be provided to the user by being included in the OS or attached to the OS. The vendor auxiliary App 17 can be, for example, a Print Support Application (PSA).

The vendor auxiliary App 17 can include a virtual printer program. However, the virtual printer program can also be implemented to be included in the general-purpose printer driver 16. Alternatively, the virtual printer program can be implemented separately from the general-purpose printer driver 16 and the vendor auxiliary App 17 or distributed and implemented in the general-purpose printer driver 16 and the vendor auxiliary App 17.

Schematically explained, the virtual printer program has a function of pretending a printer for the general-purpose printer driver 16 and causing the general-purpose printer driver to operate, that is, a function of providing a virtual printer to the general-purpose printer driver 16. Since the virtual printer program includes a function of providing a virtual printer to the general-purpose printer driver 16 and communicating with the cloud print server 20, the virtual printer program enables printing via the cloud print server 20.

Specifically explained, the virtual printer program is a program for causing a computer to execute first communication processing, second communication processing, and printing processing explained below. Here, the computer also indicates the terminal device 10 or the control unit 11.

The first communication processing is processing of pretending a printer for the general-purpose printer driver 16 and communicating with the general-purpose printer driver 16. Note that the communication is performed on the inside of the terminal device 10. That is, the first communication processing is processing in which the virtual printer program becomes a virtual printer and communicates with the general-purpose printer driver 16. Prior to the communication explained above, the virtual printer is generated. For example, three virtual printers respectively corresponding to the three printers such as the printer A(31) connected to the cloud print server 20 are desirably generated.

The second communication processing is processing of communicating with the cloud print server 20. The communication is communication performed via the communication unit 13. The second communication processing is used at the time of printing processing such as transmission of a print job from the terminal device 10 to the cloud print server 20. The second communication processing can also be used in generating a virtual printer.

The printing processing is processing of transmitting a print job acquired from the general-purpose printer driver 16 in the first communication processing to the cloud print server 20 in the second communication processing and causing the cloud print server 20 to perform cloud printing. For example, first, in the general-purpose printer driver 16, a print target file and a virtual printer are designated and a print job is generated. In the printing processing explained above, the virtual printer program becomes the virtual printer and acquires a print job from the general-purpose printer driver 16 and transmits the print job to the cloud print server 20 via the communication unit 13. Accordingly, the cloud print server 20 transmits the print job to a printer corresponding to the designated virtual printer among the connected printers 31 to 33 and printing in the printer is executed.

When acquiring a print job from the general-purpose printer driver 16, the vendor auxiliary App 17 can convert the print job such that printing using a unique function for the printer corresponding to the designated virtual printer can be executed by the printer. When the conversion is performed, in the printing processing explained above, the print job converted by the vendor auxiliary App 17 can be transmitted to the cloud print server 20 via the communication unit 13. Accordingly, the cloud print server 20 transmits the converted print job to the printer corresponding to the designated virtual printer among the connected printers 31 to 33. Printing in the printer can be executed by utilizing the unique function of the printer.

In other words, in the present embodiment, a printing method including the first communication processing, the second communication processing, and the printing processing explained above can be provided.

Further, in other words, the terminal device 10 includes the general-purpose printer driver 16 and a first communication processing unit, a second communication processing unit, and a printing processing unit explained below.

The first communication processing unit pretends a printer for the general-purpose printer driver 16 and communicates with the general-purpose printer driver 16. Since the first communication processing unit provides a virtual printer, the first communication processing unit can be referred to as virtual printer unit as well. Alternatively, since the first communication processing unit communicates with the general-purpose printer driver 16, the first communication processing unit can be referred to as driver communication unit as well. The second communication processing unit communicates with the cloud print server 20. Since the second communication processing unit communicates with the cloud print server 20, the second communication processing unit can be referred to as server processing unit as well. The printing processing unit transmits a print job acquired from the general-purpose printer driver 16 by the first communication processing unit to the cloud print server 20 in the second communication processing unit and causes the cloud print server 20 to perform cloud printing. Since the printing processing unit performs control for performing the cloud printing, the printing processing unit can be referred to as printing control unit as well.

### Configuration of the Cloud Print Server 20

As illustrated in FIG. 1, the cloud print server 20 can include a control unit 21, a storage unit 22, and a communication unit 23.

The control unit 21 controls the entire cloud print server 20. Like the control unit 11, the control unit 21 can include, for example, an arithmetic processing device, a working memory, and a storage device that stores a control program, parameters, and the like. The control unit 21 is different from the control unit 11 in the control program, the parameters, and the like. The control program in the control unit 21 includes a server program such as a Web server program. In the following explanation, the control program in the control unit 21 is simply referred to as server program and explained.

The server program can include a program for the arithmetic processing device to execute processing relating to cloud printing while cooperating with the storage unit 22 and the communication unit 23. In the following explanation, an example in which the server program, the parameters, and the like are stored in the storage unit 22 provided separately from the control unit 21 is explained. However, the storage unit 22 may be a part of a storage device in the control unit 21. That is, the storage unit 22 can be grasped as a part of the control unit 21.

The storage unit 22 is, for example, a storage device by a hard disk drive, a solid state drive, or another memory. Although not illustrated, the storage unit 12 can store a server program to be executable from the control unit 11 and can store a table in which equipment information and URIs for the printers are correlated as a part of the parameters. Note that the equipment information may be referred to as device information.

The equipment information of the printers only has to be information that can identify the printer A(31), the printer B(32), and the printer C(33). The equipment information can be used as information for designating a printer caused to execute printing from the terminal device 10. The server program can transmit, via the communication unit 23, a print job to a URI corresponding to equipment information designated from the terminal device 10.

The URIs of the printers indicate URIs of the printer A(31), the printer B(32), and the printer C(33) connected via the communication unit 23 and are registered for access to the printers. The URI can be an e-mail address. Such an example is explained below. However, a URI to be registered may be another type of URI such as a URL (Uniform Resource Locator).

The communication unit 23 is a part that communicates with an external device such as the terminal device 10 by radio or wire via the network N1 and communicates with the printers by radio or wire via the network N2 according to a predetermined communication standard such as a Wi-Fi standard or various mobile communication standards. The communication unit 23 can be configured by one or a plurality of communication interfaces capable of performing such communication.

With such a configuration, the cloud print server 20 provides a cloud printing service for performing printing in a connected printer to the terminal device 10.

Note that the cloud printing service can be provided by the same vendor as a vendor of the connected printer, that is, any printer connected to the cloud print server 20 can be only a printer of the vendor that provides the cloud printing service. However, the printer connected to the cloud print server 20 can include a printer of another vendor that is not the vendor that provides the cloud printing service. Even in this case, the virtual printer program can extend functions of the printers of other vendors in terms of the cloud printing function, that is, can be pretend a virtual printer. Note that, even when the vendor auxiliary App 17 includes a part or the entire virtual printer program, the vendor auxiliary App 17 may or may not provide extended functions for the printers of the other vendors other than the functions of the virtual printer.

### Effects of the Present Embodiment

Before a more specific processing example in the present embodiment is explained, effects by the present embodiment are explained.

As explained above, in the print system 100, the virtual printer program provides the virtual printer to the general-purpose printer driver 16 such as an IPP Class driver and communicates with the cloud print server 20 via the virtual printer. The virtual printer relays the general-purpose printer driver 16 and the cloud print server 20 that provides the cloud printing service to implement printing in the cloud printing service from the general- purpose printer driver 16. As explained above, in the print system 100, the printing in the cloud printing service can be implemented by incorporating the virtual printer program using mechanisms of the general-purpose printer driver 16 and the vendor auxiliary App 17. Therefore, according to the present embodiment, cloud printing can be executed using the general-purpose printer driver 16.

In order to supplement such effects, the present embodiment, and a print system according to a comparative example are compared. In the print system according to the comparative example, a printer is controlled using a general-purpose printer driver incorporated in the Windows (registered trademark; the same applies below) OS as a standard without using a printer driver of a vendor. In the general-purpose printer driver in this comparative example as well, a general-purpose protocol is used for a search for a printer and printing. In the general-purpose printer driver in the comparative example as well, a mechanism for starting a vendor auxiliary application program linked with a printer and customizing a custom print setting and IPP communication at the time of printing is provided. Naturally, this vendor auxiliary application or the general-purpose printer driver does not include the virtual printer program.

However, the mechanism according to the comparative example only targets a printer connected to the same network and a printer connected by a USB(registered trademark; the same applies below). The cloud printing service provided by the vendor cannot be used. Note that USB is an abbreviation of Universal Serial Bus.

As explained above, in the comparative example explained above, the cloud printing using the general-purpose printer driver cannot be implemented. On the other hand, as explained above, according to the present embodiment, cloud printing using the general-purpose printer driver 16 can be implemented via the virtual printer by introducing the virtual printer program.

### Overview of a Processing Example

A specific processing example in the present embodiment is explained below. In the processing example explained here, in preparation for printing processing, printer queue registration processing corresponding to registration processing for a virtual printer is executed. In the following explanation, printer queue registration processing and printing processing of two patterns are explained by way of example. In the printer queue registration processing, a printing capability is acquired from the cloud print server 20 and a virtual printer is disclosed based on the printing capability. In all kinds of printing processing explained below, print data is passed from the general-purpose printer driver 16 to the virtual printer and the virtual printer communicates with the cloud printing service, whereby the general-purpose printer driver 16 and the cloud printing service are relayed. Here, the cloud printing service can indicate a server program in the cloud print server 20.

### Printer Queue Registration Processing

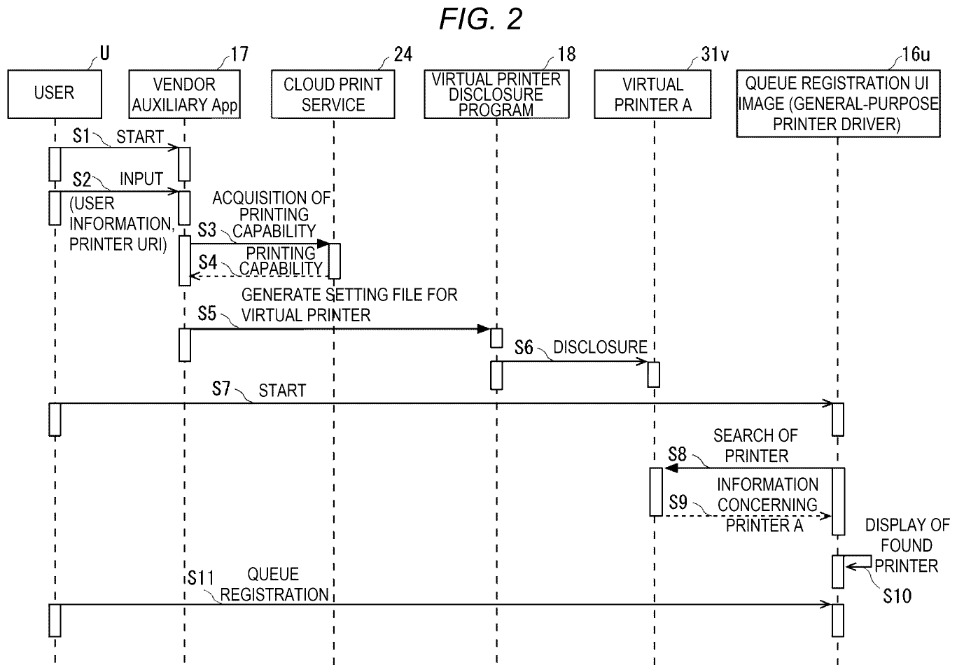

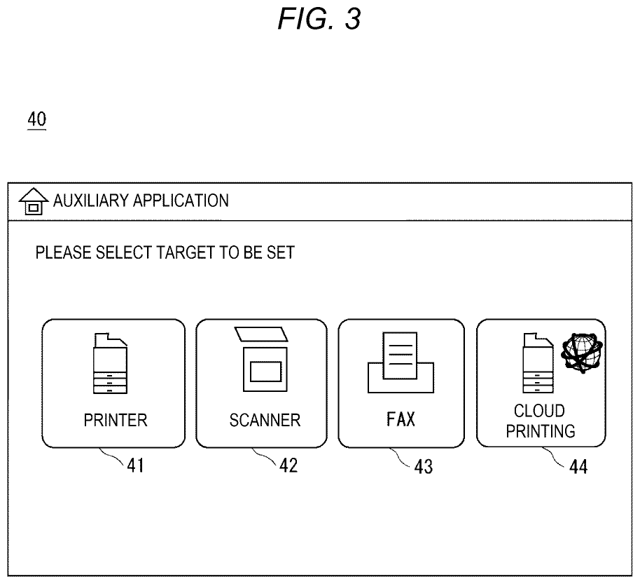

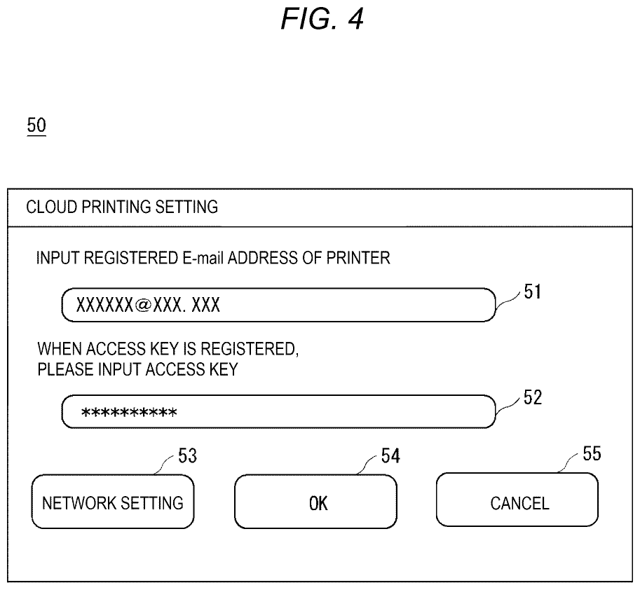

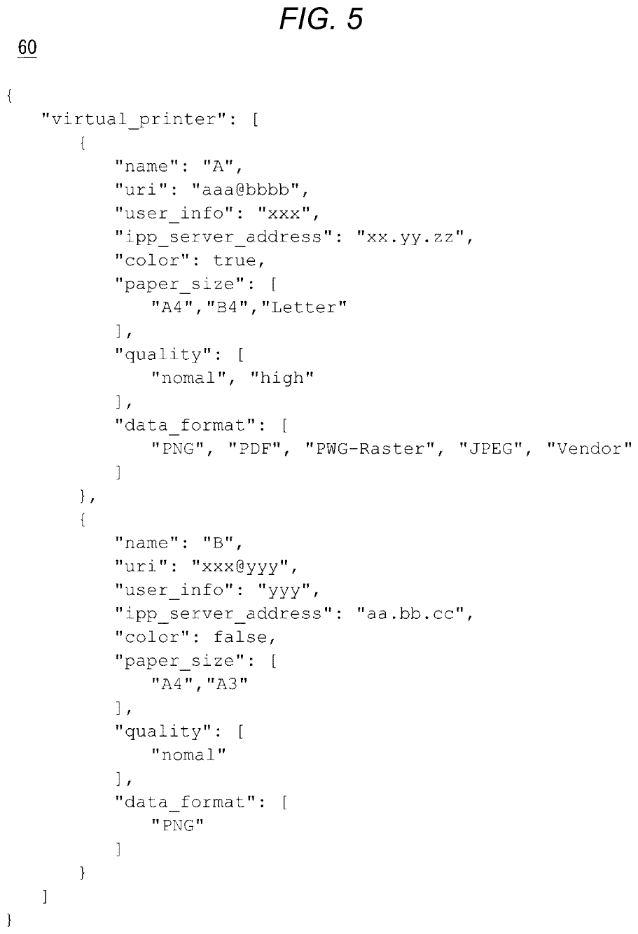

Printer queue registration processing of registering a virtual printer is explained with reference to FIGS. 2 to 5. FIG. 2 is a sequence diagram illustrating an example of printer queue registration processing in the print system 100. FIG. 3 is a diagram illustrating an example of a UI image displayed in the registration processing illustrated in FIG. 2. FIG. 4 is a diagram illustrating an example of a UI image displayed when cloud setting is selected in the UI image illustrated in FIG. 3. FIG. 5 is a diagram illustrating an example of a setting file generated in the registration processing illustrated in FIG. 2.

First, a user U of the terminal device 10 starts the vendor auxiliary App 17 via the operation unit 14 (step S1). The vendor auxiliary App 17 causes the display unit 15 to display, for example, a UI image 40 illustrated in FIG. 3. The UI image 40 includes a button 41 for advancing to a UI image for setting a printer, a button 42 for advancing to a UI image for setting a scanner, a button 43 for advancing to a UI image for setting a FAX, and a button 44 for advancing to a UI image for setting cloud printing. A target to be set included in the UI image 40 does not matter. Examples of other targets include a camera and other devices. However, the UI image 40 only has to include the button 44 for advancing to a UI image for setting cloud printing, that is, a UI image for registering a virtual printer. By selecting a button included in the UI image 40, the vendor auxiliary App 17 can display a UI image for performing setting for a target function or device of the button.

Here, the setting includes setting serving as an extended function of the general-purpose printer driver 16. For example, when the button 44 is selected, the processing proceeds to a UI image 50 exemplified in FIG. 4 for generating a virtual printer serving as an extended function.

In the vendor auxiliary App 17, when the button 44 is selected in the UI image 40 or at a stage of starting the vendor auxiliary App 17 in the step S1 not through the display of the UI image 40, the UI image 50 illustrated in FIG. 4 can be displayed on the display unit 15. The UI image 50 is a UI image for inputting user information of the vendor auxiliary App 17 and a URI of a printer set as a virtual printer. The UI image 50 can include an input field 51 for an e-mail address serving as the URI of the printer and an input field 52 for an access key. Further, the UI image 50 can include an OK button 54 that is selected when setting is performed with input content and a cancel button 55 that is selected when the input content is discarded and the UI image 50 is closed. Note that the UI image 50 is a UI image for cloud printing setting and can further include a network setting button 53. The network setting button 53 is, for example, a button selected when displaying a UI image for performing setting concerning network connection to the cloud print server 20.

Subsequent to step S1, the user U inputs the user information and the printer URI registered in a cloud printing service 24 from the UI image 50 via the operation unit 14 (step S2). Specifically, as explained above, the user U performs input to the input field 51 or the input field 51 and the input field 52 and selects the OK button 54. In the following explanation, an example in which a virtual printer is generated only for the printer A(31) is explained.

Subsequently, the vendor auxiliary App 17 communicates with the cloud printing service 24 based on the input information, requests user authentication based on the user information, and requests acquisition of printing capability information linked with the printer URI (step S3). Note that the illustration of the user authentication is omitted.

When the user authentication is successful, the vendor auxiliary App 17 acquires the printing capability information from the cloud printing service 24 as a response of the user authentication (step S4). When failing in the user authentication, the vendor auxiliary App 17 desirably returns, as a response to the failure in the user authentication, a message indicating that the vendor auxiliary App 17 has failed in the user authentication.

The printing capability information that the vendor auxiliary App 17 can acquire from the cloud printing service 24 is information indicating printing capability of the printer indicated by the printer URI. Examples of the printing capability include a support print data format, a color printing support, a support paper size, and a support print quality. Printing capability can also be referred to as printing capability.

Here, the supported print data format refers to a supported format of print data. Examples of the support print data format include PNG, PDF, PWG-Raster, JPEG, and a unique format of a vendor. PNG is an abbreviation of Portable Network Graphics. PDF is an abbreviation of Portable Document Format. PWG is an abbreviation of Printer Working Group. JPEG is an abbreviation of Joint Photographic Experts Group. The color print support indicates whether color printing is supported. Not supporting color printing indicates that only monochrome printing is supported. The support paper size and the support print quality respectively indicate supported paper size and supported print quality.

Subsequently, the vendor auxiliary App 17 generates a setting file for the virtual printer based on the acquired printing capability information and passes the setting file to a virtual printer disclosure program 18 (step S5). The virtual printer disclosure program 18 can be provided while being included in the vendor auxiliary App 17 or the general-purpose printer driver 16. The virtual printer disclosure program 18 can be provided as a program included in the virtual printer program. However, the virtual printer disclosure program 18 can also be provided as a program different from the virtual printer program. This is because the virtual printer program only has to be capable of communicating with, using a disclosed virtual printer, the general-purpose printer driver 16 as the virtual printer.

The setting file for the virtual printer can be generated as a file including printing capability information acquired for a target printer like, for example, a file 60 in a json format illustrated in FIG. 5. When there are a plurality of target printers, the file 60 can be generated as a file including printing capability information acquired for the printers. In the file 60, a name “name”, a URI “uri”, user information “user_info”, and an address of an IPP server “ipp_server_address” are described for each of the target printers. Further, in the file 60, color printing support “color”, support print size “paper_size”, support print quality “quality”, and support print data format “data_format” are also described for each of the target printers. In the file 60, an example in which the printers A(31) and B(32) are described is given.

Subsequently, the virtual printer disclosure program 18 discloses the virtual printer based on the setting file such as the file 60 (step S6). In FIG. 2, for convenience, only a virtual printer A(31v), which is a virtual printer of the printer A(31), is illustrated as a virtual printer. In step S6, the virtual printer disclosure program 18 discloses the virtual printer A(31v) as one of IPP print services, for example, using an mDNS/DNS-SD function. The address of the IPP server in the file 60 indicates an address where a target virtual printer is disclosed.

Here, the virtual printer disclosure program 18 and the mDNS/DNS-SD are supplementarily explained. The virtual printer disclosure program 18 is exemplified by an mDNS/DNS-SD server program or a program including the server program. The virtual printer disclosure program 18 can be a program that provides a service disclosure function and a printer address resolution function as an mDNS/DNS-SD function.

The mDNS/DNS-SD is provided as, for example, a part of functions of Bonjour (registered trademark; the same applies below) provided by Apple (registered trademark) corporation. The Bonjour is a program in which a technique such as Zeroconf (Zero-configuration networking) is implemented. The Zeroconf is a series of techniques for automatically generating an available IP (Internet Protocol) network not via manual operation and without using a special configuration server. The virtual printer disclosure program 18 has a function of disclosing printer information on a network using such an mDNS/DNS-SD mechanism. A virtual printer based on the printing capability of the printer can be disclosed in the mDNS/DNS-SD as the printer information.

After the virtual printer is disclosed in step S6, the user U performs, on the operation unit 14, operation for starting a queue registration UI image 16u of the general-purpose printer driver 16, whereby the queue registration UI image 16u is started (step S7). The queue registration UI image 16u is a UI image for registering a printer queue. The general-purpose printer driver 16 searches for a printer before or during display of the queue registration UI image 16u (step S8).

Since the virtual printer A(31v) is disclosed in step S6, a search destination for the virtual printer A(31v) includes the printer A(31) serving as the virtual printer A(31v). Thus, the general-purpose printer driver 16 receives information such as equipment information of the printer A from the found virtual printer A(31v) as a search response (step S9). Naturally, by the search in step S8, printers other than the virtual printer A(31v) are sometimes found. In that case, the general-purpose printer driver 16 also receives information concerning the printers.

Subsequently, the general-purpose printer driver 16 displays information indicating the printers found as a result of the search as a list of printers in the queue registration UI image 16u (step S10). This list also includes the virtual printer A(31v). Subsequently, the user U selects the virtual printer A(31v) as the printer A(31) from the operation unit 14 in the queue registration UI image 16u. The general-purpose printer driver 16 registers a printer queue for the selected printer A(31) (step S11).

With such registration processing, the user U is capable of performing printing processing in which the printer A(31) is selected in the terminal device 10 and, actually, performing printing processing in which the virtual printer A(31v) is selected. Although the printing processing is explained below, one of the two pattern processing examples can be adopted according to implementation destination of a program for executing the first communication processing in the virtual printer program, in other words, according to a provision source of the virtual printer.

In the example of the registration processing explained above, an example in which the virtual printer is generated only for the printer A(31) is explained. However, the same applies to the printer B(32) and the printer C(33). Further, as a modification of the UI image 50, all virtual printers can be generated at a time by providing a UI image capable of inputting printer URIs for a plurality of printers.

As exemplified in the processing of steps S3 to

S6, the first communication processing may pretend a printer having the capability of the printer acquired from the cloud print server 20 in the second communication processing. Such processing is different between (1) a case in which a program for executing the first communication processing in the virtual printer program is implemented in the general-purpose printer driver 16 or the OS and (2) a case in which the program is implemented in other than the general-purpose printer driver 16 or the OS like the vendor auxiliary App 17.

In the case of (1), the virtual printer program can include a program for causing the computer exemplified by the terminal device 10 to execute the following processing. Such processing is processing of setting, in the general-purpose printer driver 16 or an OS of the computer, the capability of the printer acquired from the cloud print server 20 in the second communication processing and specifying the first communication processing. In the case of (1), the printing processing is, for example, printing processing explained below in a first example.

In the case of (2), the virtual printer program can include a program that for causing the computer exemplified by the terminal device 10 to execute the following processing. Such processing is processing of causing the computer to set, in the computer, the capability of the printer acquired from the cloud print server 20 in the second communication processing and specify the first communication processing. In the case of (2), the printing processing is, for example, printing processing explained below in a second example.

### First Example of the Printing Processing

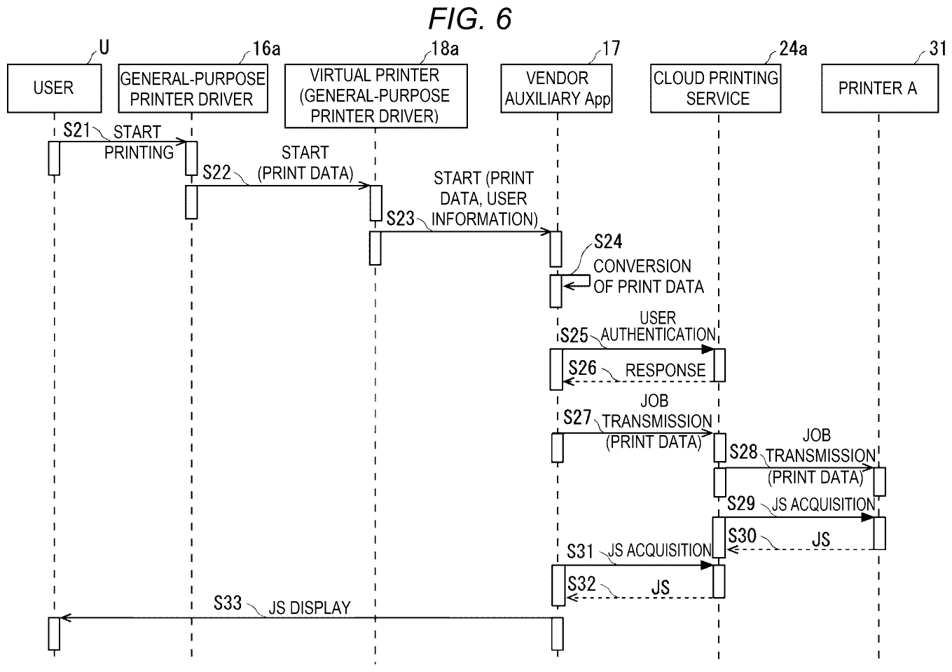

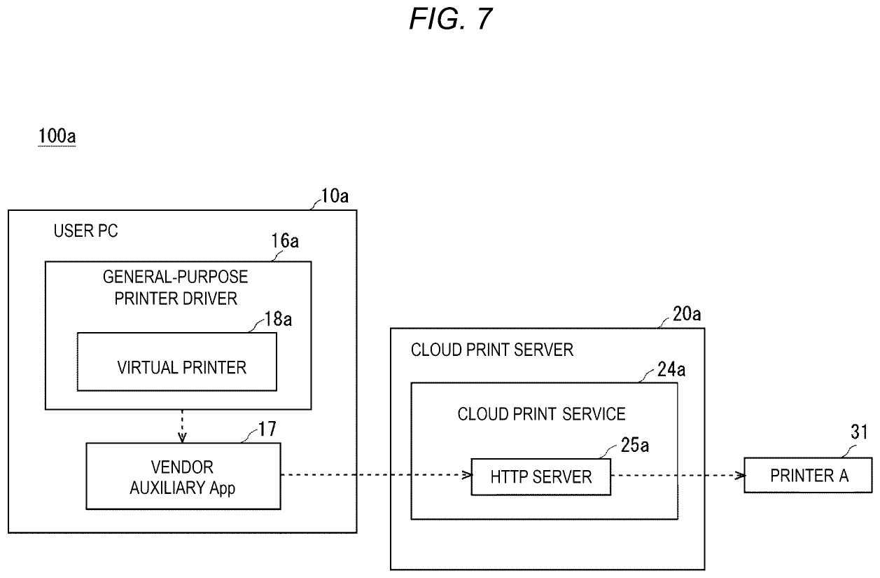

A first example of the printing processing is explained with reference to FIGS. 6 and 7. FIG. 6 is a sequence diagram illustrating a first example of printing processing executed by the print system 100 illustrated in FIG. 1. FIG. 7 is a block diagram illustrating a detailed example of a part of the print system 100 illustrated in FIG. 1 and illustrating a configuration example of a print system that executes the printing processing illustrated in FIG. 6.

The first example is an example in which the general-purpose printer driver 16 of the OS includes a virtual printer disclosure program and includes a disclosure function for a virtual printer. Further, in the first example, the general-purpose printer driver 16 of the OS is equipped with a mechanism for transferring print data for the virtual printer to the vendor auxiliary App 17. In this case, in the virtual printer program, a program for executing the first communication processing and passing the print job to the vendor auxiliary App 17 is implemented in the general-purpose printer driver 16. Then, a program for executing the second communication processing and the printing processing in the virtual printer program is implemented in the vendor auxiliary App 17.

As illustrated in FIG. 7, a print system 100a, which is a first example of the print system 100, includes a user PC 10a, which is an example of the terminal device 10, a cloud print server 20a, which is an example of the cloud print server 20, and the printer A(31).

The user PC 10a includes a general-purpose printer driver 16a that discloses a virtual printer 18a in the general-purpose printer driver 16 and the vendor auxiliary App 17. The cloud print server 20a and a cloud printing service 24a include an HTTP server 25a in the cloud printing service 24 in order to communicate with the vendor auxiliary App 17 respectively in the cloud print server 20 and the cloud printing service 24.

In such the print system 100a, first, the user U starts an application program for, for example, starting and editing a print target file such as a document file. Then, the user U performs, for example, operation for selecting the virtual printer A(31v) in print setting for the print target file from the operation unit 14, whereby the general-purpose printer driver 16a receives an instruction to start printing (step S21).

The general-purpose printer driver 16a converts the print target file into print data that is data in a printable format and, since the virtual printer 18a, which is the virtual printer A(31v), is selected, starts the virtual printer 18a and passes the print data to the virtual printer 18a (step S22). The virtual printer 18a, which is the virtual printer A(31v), starts the vendor auxiliary App 17 by transmitting the received print data and the user information set in the virtual printer A(31v) to the vendor auxiliary App 17 (step S23). This transmission is inter-process communication.

The vendor auxiliary App 17 converts the received print data into a format for the cloud printing service 24a according to necessity (step S24). Before this conversion, the user U can also instruct print setting using an extended function other than the cloud printing function as print setting for the virtual printer A(31v). In this case, in step S24, the vendor auxiliary App 17 performs the conversion according to the instructed print setting. In step S22, the general-purpose printer driver 16a may pass the print target file to the virtual printer 18a without converting the print data and convert the print target file into a format for the cloud printing service 24a in step S24.

Subsequently, the vendor auxiliary App 17 requests the cloud printing service 24a to perform user authentication based on the user information (step S25) and obtains an authentication result as a response to the user authentication request (step S26). The communication between the vendor auxiliary App 17 and the cloud print server 20a including the communication here is communication conforming to the HTTP protocol and is communication between the vendor auxiliary App 17 and the HTTP server 25a. The following explanation is based on the premise that the vendor auxiliary App 17 has succeeded in the user authentication.

The vendor auxiliary App 17 transmits a print job including print data to the cloud printing service 24a (step S27). The cloud printing service 24a transmits the print job to the printer A(31) corresponding to the virtual printer A(31v) (step S28). The printer A(31) receives the print job and performs printing to produce a print.

Thereafter, the cloud printing service 24a periodically requests the printer A(31) to acquire a job status (JS), which is a status of the print job, (step S28) and receives the JS as a response to the request (step S30). The vendor auxiliary App 17 periodically requests the cloud printing service 24a to acquire the JS (step S31) and receives the JS as a response to the request (step S32). The vendor auxiliary App 17 causes the display unit 15 to display the acquired JS such that the user U can check the JS (step S33).

As exemplified in step S24, the printing processing explained above can also be performed by converting the print job acquired from the general-purpose printer driver 16a in the first communication processing and then transmitting the converted print job to the cloud print server 20a. The conversion of the print job can be executed such that the print job changes to a print job using a unique function of a printer that is a print destination in the cloud printing service 24a.

Further, as exemplified in steps S31 and S32, the printing processing explained above may include processing of acquiring a status of a print job from the cloud print server 20a in the second communication processing after causing the cloud printing server 20a to perform the cloud printing.

In the example explained above, the vendor auxiliary App 17 displays the JS. However, the printing processing explained above may include processing of notifying the JS acquired from the cloud print server 20a to the general-purpose printer driver 16a in the first communication processing. Accordingly, the general-purpose printer driver 16a can acquire the JS in addition to the print instruction to the cloud printing service 24a provided by the vendor.

As exemplified in the first example, in the second communication processing explained above, communication may be performed with the cloud print server 20a via another application program installed in a computer in which the virtual printer program is installed. This computer is exemplified by the user PC 10a. The other application program explained above is exemplified by the vendor auxiliary App 17.

### Second Example of the Printing Processing

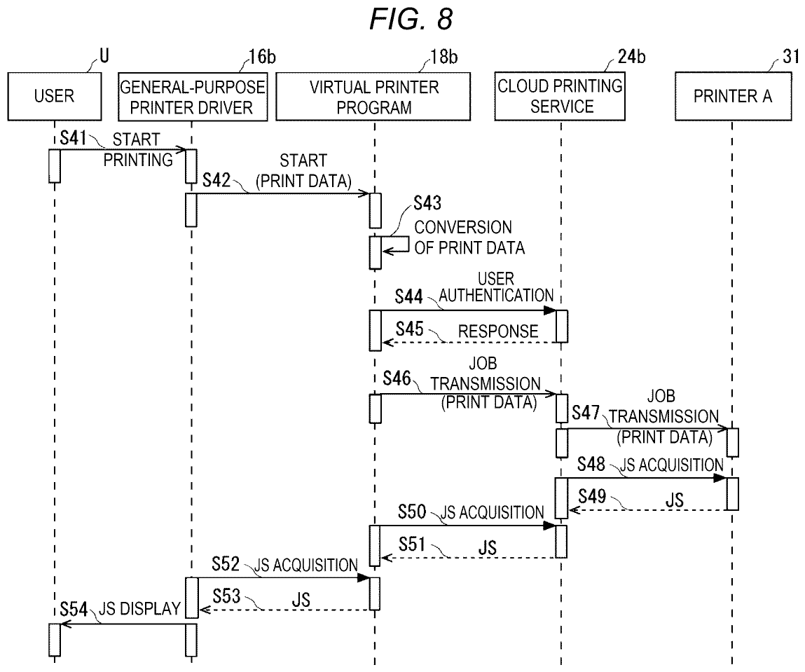

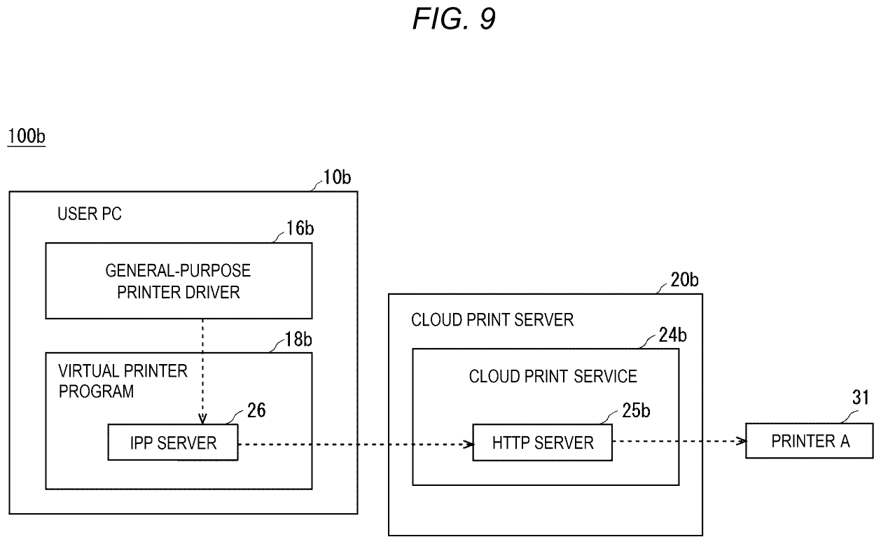

A second example of the printing processing is explained with reference to FIGS. 8 and 9. FIG. 8 is a sequence diagram illustrating a second example of printing processing executed by the print system 100 of FIG. 1. FIG. 9 is a block diagram illustrating a detailed example of a part of the print system 100 illustrated in FIG. 1 and illustrating a configuration example of a print system that executes the printing processing illustrated in FIG. 8.

The second example is an example in which, unlike the first example, the OS including the general-purpose printer driver 16 does not provide a virtual printer disclosure function. That is, the second example is an example in which the virtual printer program is implemented separately from the general-purpose printer driver 16, for example, implemented in the vendor auxiliary App 17 and the virtual printer program communicates with the cloud printing service. In the second example, the virtual printer is disclosed in the terminal device 10 other than in the general-purpose printer driver 16. The virtual printer program in the second example has a function of an IPP server in order to disclose the virtual printer.

As illustrated in FIG. 9, a print system 100b, which is a second example of the print system 100, includes a user PC 10b, which is an example of the terminal device 10, a cloud print server 20b, which is an example of the cloud print server 20, and the printer A(31).

The user PC 10b includes a general-purpose printer driver 16b not including the virtual printer publishing function in the general-purpose printer driver 16 and a virtual printer program 18b including a function of an IPP server 26 that discloses a virtual printer. The cloud print server 20b and a cloud printing service 24b include an HTTP server 25b in the cloud printing service 24 in order to communicate with the IPP server 26 respectively in the cloud print server 20 and the cloud printing service 24.

The print system 100b explained above, first, the user U starts an application program for, for example, starting and editing a print target file such as a document file. Then, the user U performs operation for instructing cloud printing in print setting of the print target file from the operation unit 14, whereby the general-purpose printer driver 16b receives an instruction to start printing (step S41).

The general-purpose printer driver 16b converts the print target file into print data that is data in a printable format and, since cloud printing is instructed, starts the virtual printer program 18b to pass the print data to the virtual printer program 18b (step S42). The print data here is transmitted by IPP communication. The started virtual printer program 18b can receive, from the user U, operation for selecting a virtual printer and operation for instructing print setting using an extended function other than the cloud printing function as print setting for the virtual printer. In the following explanation, it is assumed that the virtual printer A(31v) is selected.

The virtual printer program 18b converts the received print data into a format for the cloud printing service 24b according to necessity based on the print setting of the virtual printer A(31v) (step S43). In step S42, the print target file may be passed to the virtual printer program 18b without converting the print data and the print target file may be converted into a format for the cloud printing service 24b in step S43.

Subsequently, the virtual printer program 18b requests the cloud printing service 24b to perform user authentication based on user information (step S44) and obtains an authentication result as a response to the request (step S45). As the user information to be used here, the virtual printer program 18b only has to read the user information set in the virtual printer A(31v). Communication between the virtual printer program 18b and the cloud print server 20b including communication performed here is communication conforming to the HTTP protocol and is communication between the IPP server 26 and the HTTP server 25b. The following explanation is based on the premise that the vendor auxiliary App 17 has succeeded in the user authentication.

The virtual printer program 18b transmits a print job including print data to the cloud printing service 24b (step S46). The cloud printing service 24b transmits the print job to the printer A(31) corresponding to the virtual printer A(31v) (step S47). The printer A(31) receives the print job and performs printing to produce a print.

Thereafter, the cloud printing service 24b periodically requests the printer A(31) to acquire the JS (step S48) and receives the JS as a response to the request (step S49). The virtual printer program 18b periodically requests the cloud printing service 24b to acquire the JS (step S50) and receives the JS as a response to the request (step S51). The general-purpose printer driver 16b periodically requests the virtual printer program 18b to acquire the JS (step S52) and receives the JS as a response to the request (step S53). The general-purpose printer driver 16b causes the display unit 15 to display the acquired JS such that the user U can check the JS (step S54).

As exemplified in steps S50 and S51, the printing processing explained above may include processing of acquiring a status of a print job from the cloud print server 20b in the second communication processing after causing the cloud print server 20b to perform the cloud printing.

As exemplified in steps S52 and S53, the printing processing explained above may include processing of notifying the JS acquired from the cloud print server 20b to the general-purpose printer driver 16b in the first communication processing. Accordingly, the general-purpose printer driver 16b can acquire the JS in addition to the print instruction to the cloud printing service 24b provided by the vendor.

Note that, even if the virtual printer program 18b is implemented in the vendor auxiliary App 17 or is implemented in the user PC 10b separately from the vendor auxiliary App 17, the second example can be applied in the same manner if the virtual printer program 18b is not implemented in the general-purpose printer driver 16.

### REFERENCE EXAMPLE

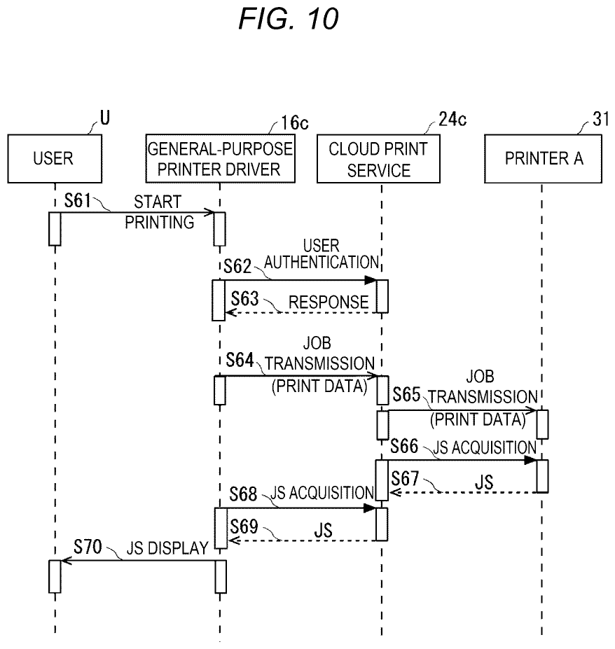

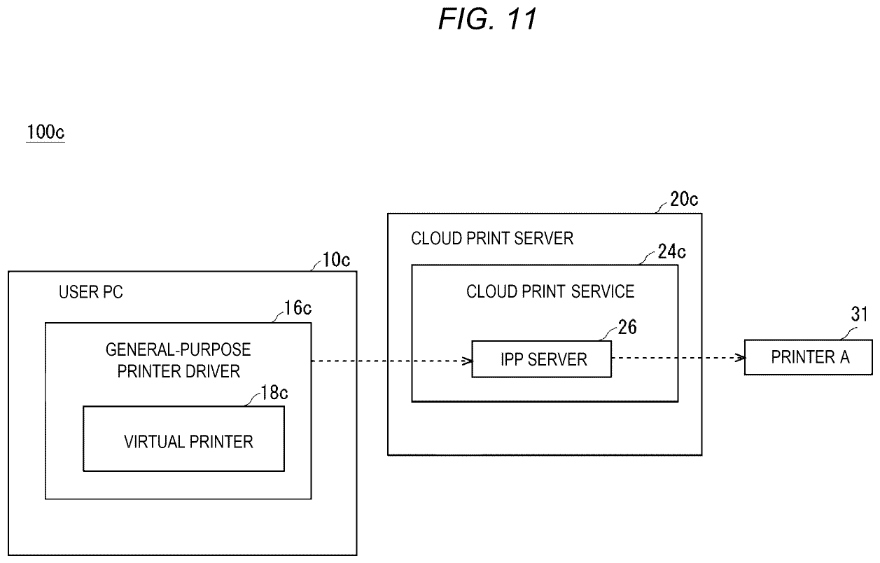

As a reference example, a case in which a cloud printing service is adapted to the IPP is explained with reference to FIGS. 10 and 11. FIG. 10 is a sequence diagram illustrating printing processing executed by a print system according to the reference example. FIG. 11 is a block diagram illustrating details of a part of the print system according to the reference example and illustrating a configuration of the print system that executes the printing processing illustrated in FIG. 10.

The reference example is an example in which a general-purpose printer driver communicates with a cloud printing service adapted to the IPP. In the reference example, an OS including the general-purpose printer driver or a vendor auxiliary App may disclose the cloud printing service as a virtual printer.

As illustrated in FIG. 11, a print system 100c according to the reference example includes a user PC 10c, a cloud print server 20c, and the printer A(31). The user PC 10c includes a general-purpose printer driver 16c including a virtual printer 18c. The cloud print server 20c is implemented with a cloud printing service 24c including the IPP server 26.

In the print system 100c, first, the user U starts an application program for, for example, starting and editing a print target file such as a document file. Then, the user U performs, from the operation unit, operation for selecting the virtual printer A(31v) in print setting of the print target file, whereby the general-purpose printer driver 16c receives an instruction to start printing (step S61).

The general-purpose printer driver 16c requests the cloud printing service 24c to perform user authentication based on user information (step S62) and obtains an authentication result as a response to the request (step S63). Communication between the general-purpose printer driver 16c and the cloud print server 20c including communication performed here is IPP communication. The following explanation is based on the premise that the vendor auxiliary App 17 has succeeded in the user authentication.

The general-purpose printer driver 16c converts the print target file into print data that is data in a printable format and transmits a print job including the print data to the cloud printing service 24c (step S64). The cloud printing service 24c transmits the print job to the printer A(31) corresponding to the virtual printer A(31v) (step S65).

Thereafter, the cloud printing service 24c periodically requests the printer A(31) to acquire the JS (step S66) and receives the JS as a response to the request (step S67). The general-purpose printer driver 16c periodically requests the cloud printing service 24c to acquire the JS (step S68) and receives the JS as a response to the request (step S69). The general-purpose printer driver 16c causes the display unit to display the acquired JS such that the user U can check the JS (step S70).

### Other Modifications

The present disclosure is not limited to the embodiment explained above and can be modified as appropriate without departing from the gist of the present disclosure. For example, the system configuration of the print system, the configurations of the devices configuring the system, the configurations of the programs included in the devices, the processing procedures of the devices, and the like are not limited to the exemplified ones. A part of the functions of the devices and the programs and a part of the steps of the method only have to be included therein to achieve the explained effects.

For example, the virtual printer program may be a program for causing a computer to execute first processing or second processing explained below. The first processing includes first communication processing and processing of transferring a print job acquired from the general-purpose printer driver in the first communication processing to a printing processing program for causing a printer connected to a cloud print server via a network to perform printing. The second processing includes processing of receiving a print job acquired by pretending a printer in the general-purpose printer driver and for causing the printer to execute printing and communication processing of communicating with the cloud print server. The second processing further includes printing processing of transmitting the print job to the cloud print server in the communication processing and causing the printer connected to the cloud print server via the network to perform printing. Alternatively, the second processing is printing processing of transmitting, to a print server, a print job acquired from the general-purpose printer driver by presenting a printer for the general-purpose printer driver and communicating with the general-purpose printer driver and causing the printer connected to the print server via the network to perform printing based on the print job. A printing method can be a method including the first processing or the second processing explained above.

In the embodiment and the modifications explained above, the print system including the cloud print server is explained. However, another print server such as an on-premises print server may be applied instead of the cloud print server. For example, in the explanation of the print system 100 explained above, the print system can be explained by replacing the cloud print server 20 as an on-premises print server and replacing the cloud printing as on-premises printing. In this case, the network N1 and the network N2 can be the same local area network.

That is, in the printing processing in the virtual printer program or the printing method, the print job acquired from the general-purpose printer driver in the first communication processing is transmitted to the print server in the second communication processing. The printing processing causes the printer connected to the print server via the network to perform printing. With the print system having such a configuration, it is possible to execute printing via the print server such as cloud printing or on-premises printing using a general-purpose printer driver such as an OS standard printer driver.

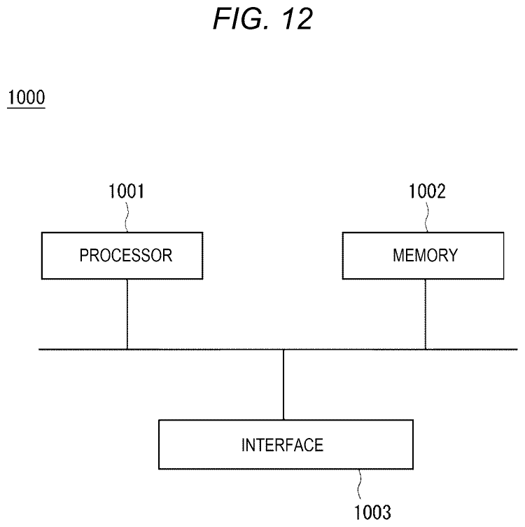

The devices provided in the print system according to the embodiment explained above may include, for example, a hardware configuration explained below. Here, examples of the devices include the terminal device, the cloud print server, and the printer referring to the example illustrated in FIG. 1. FIG. 12 is a diagram illustrating an example of a hardware configuration of a device.

A device 1000 illustrated in FIG. 12 can include a processor 1001, a memory 1002, and an interface 1003. The interface 1003 can include, for example, a communication interface and an interface with an input and output device that are required according to the device.

The processor 1001 may be, for example, a CPU, a GPU, or a microprocessor unit (MPU) also referred to as microprocessor. The processor 1001 may include a plurality The memory 1002 is configured by, for of processors.

example, a combination of a volatile memory and a nonvolatile memory. Functions in the devices are implemented by the processor 1001 reading a program stored in the memory 1002 and executing the program while exchanging necessary information via the interface 1003.

The program includes an instruction group (or software codes) for causing a computer to perform the one or more functions explained in the embodiment when the program is read in the computer. The program may be stored in a non-transitory computer-readable medium or a tangible storage medium. Not as a limitation but as an example, the computer-readable medium or the tangible storage medium includes a random-access memory (RAM), a read-only memory (ROM), a flash memory, a solid-state drive (SSD), or another memory technology. Not as a limitation but as an example, the computer-readable medium or the tangible storage medium includes a CD-ROM, a digital versatile disc (DVD), a Blu-ray (registered trademark) disk, or another optical disc storage or a magnetic cassette, a magnetic tape, a magnetic disk storage, or another magnetic storage device. The program may be transmitted on a transitory computer-readable medium or a communication medium. Not as a limitation but as an example, the transitory computer-readable medium or the communication medium includes a propagation signal of an electric, optical, acoustic, or another form.

The present disclosure is explained above with reference to the embodiment. However, the present disclosure is not limited to only the configuration in the embodiment explained above. It goes without saying that the present disclosure includes various modifications, alterations, and combinations that can be made by those skilled in the art within the scope of the disclosure of the claims of the present application.

What is claimed is:

1. A non-transitory computer-readable storage medium storing a virtual printer program, the virtual printer program causing a computer to execute:
first communication processing of pretending a printer for a general-purpose printer driver and communicating with the general-purpose printer driver;
second communication processing of communicating with a print server; and
printing processing of transmitting a print job acquired from the general-purpose printer driver in the first communication processing to the print server in the second communication processing and causing a printer connected to the print server via a network to perform printing.

2. The non-transitory computer-readable storage medium storing the virtual printer program according to claim 1, wherein the printing processing includes processing of, after causing the printer to perform the printing, acquiring a status of the print job from the print server in the second communication processing and notifying the acquired status to the general-purpose printer driver in the first communication processing.

3. The non-transitory computer-readable storage medium storing the virtual printer program according to claim 1, wherein, in the printing processing, the print job acquired from the general-purpose printer driver in the first communication processing is converted and then transmitted to the print server.

4. The non-transitory computer-readable storage medium storing the virtual printer program according to claim 1, wherein, in the second communication processing, communication is performed with the print server via another application program installed in the computer.

5. The non-transitory computer-readable storage medium storing the virtual printer program according to claim 1, wherein, in the first communication processing, a printer having a capability of a printer acquired from the print server in the second communication processing is pretended.

6. The non-transitory computer-readable storage medium storing the virtual printer program according to claim 5, the virtual printer program further comprising a program for causing the computer to execute processing of setting the capability of the printer acquired from the print server in the second communication processing in an operating system of the general-purpose printer driver or the computer and specifying the first communication processing.

7. The non-transitory computer-readable storage medium storing the virtual printer program according to claim 5, the virtual printer program further comprising a program for causing the computer to execute processing of setting the capability of the printer acquired from the print server in the second communication processing in the virtual printer program and specifying the first communication processing.

8. A printing control device comprising:
a general-purpose printer driver;
a first communication processing unit configured to pretend a printer for the general-purpose printer driver and communicate with the general-purpose printer driver;
a second communication processing unit configured to communicate with a print server; and
a printing processing unit configured to transmit a print job acquired from the general-purpose printer driver by the first communication processing unit to the print server with the second communication processing unit and cause a printer connected to the print server via a network to perform printing.

9. A printing method comprising printing processing of:
transmitting, to a print server, a print job acquired from a general-purpose printer driver by pretending a printer for the general-purpose printer driver and communicating with the general-purpose printer driver; and
causing a printer connected to the print server via a network to perform printing based on the print job.
